(19) United States
(12) Patent Application Publication
(10) Pub. No.: US 2007/0044689 A1
(43) Pub. Date: Mar. 1, 2007

(54) Antiskinning compound and compositions containing them

(76) Inventors: Nicholas M. Martyak, Bucks County, PA (US); Daniel Alford, Montgomery County, PA (US)

Correspondence Address: Steven D. Boyd;Arkema Inc., 2000 Market Street, Philadelphia, PA, 19103, US

(21) Appl. No.: 11/214,558

(22) Filed: Aug. 30, 2005

(51) Int. Cl. C04B 40/00

(52) U.S. Cl. 106/823

(57) ABSTRACT

The invention relates to a coating material, paint or finish which contains as anti-skinning agents a combination of at least one organic and/or inorganic oxygen scavengers and a nitrogen-containing aromatic compound and also relates to compositions containing the combination, especially oxidatively drying paints or coating compositions and articles coated with such oxidatively drying paints or coating compositions.

### FIELD OF THE INVENTION

The invention relates to anti-skinning agents for oxidatively drying coatings. The anti-skinning agents comprise mixtures of compounds, that is combinations of organic or inorganic oxygen scavengers and nitrogen-containing aromatic compounds. The invention further relates to coating compositions containing such anti-skinning agents and articles coated with them. The invention further relates to compositions containing these anti-skinning agents, like coating compositions such as oxidatively drying alkyd resins.

### BACKGROUND OF THE INVENTION

Colorless and pigmented oxidatively drying paints and coatings based on oxidatively drying oils, alkyd resins, epoxy esters and other oxidatively drying refined oils are known. These oils and binders crosslink oxidatively under the influence of oxygen (preferably atmospheric oxygen) by means of the addition of driers, such as metal carboxylates of transition metals; If this crosslinking takes place before the product is actually used, a solid barrier film, a skin, can form on the surface. Skin formation can occur in open or closed containers. This is highly undesirable and should therefore be avoided since it makes the paint more difficult to work with, and commonly interferes with the uniform distribution of the driers. The accumulation of the driers in the paint skin that forms can lead to considerable delays in the drying of the paint when it is applied.

Skinning of the paint film after application is also disadvantageous. Excessively rapid drying of the surface of the paint prevents the lower film layers from drying evenly because they are shielded from oxygen, which is prevented from sufficiently penetrating into and dispersing within the paint film. This can lead among other things to flow problems in the paint film, adhesion problems, or insufficiently hard films.

It is known to add organic substances to a paint that inhibit the reaction of the drier with (atmospheric) oxygen by binding the oxygen or by complexing of the drier metal.

U.S. Pat. No. 4,618,371 describes the use of aliphatic α-hydroxy ketones as anti-skinning agents. DE-A 1 519 103 discloses N,N-dialkylated hydroxylamines for this purpose. Because of their low volatility, however, hydroxylamines alone can lead to severe delays in drying and often also to reduced film hardness values, so that their possible applications are limited. They have not been able to gain commercial acceptance as anti-skinning agents. U.S. Pat. No. 6,730,157 describes the use of organic hydroxylamines such as diethylhydroxylamine and β-dicarbonyl compounds such as diethylformamide as anti-skinning agents. US patent application publication 2003/0047112 discloses a mixture of an aliphatic amine and/or its salt with a compound of the formula specified therein, such as diethyl formamide as an antiskinning additive for lacquer systems. U.S. Pat. No. 6,224,659 discloses the use of a combination of tin compounds as antiskinning agents for oxidatively drying binders.

A central issue in alkyd resin technology is to quickly cure, or dry the resin which occurs via oxidative crosslinking, while maintaining adequate anti-skinning properties. Oxidatively drying coatings typically include one or more “driers” such as metals to assist in the oxidative drying reaction. Combinations of a primary drier and a secondary drier are common. Cobalt is currently the most commonly used primary drier although other metals from Groups 1A, 2A, 3A, 4A, 5A, 1B, 2B, 3B, 4B, 5B, 6B, 7B and 8B of the periodic table or combinations thereof can be employed.

Anti-skinning requires slowing the oxidative curing reaction at the air-resin interface while drying requires acceleration of the oxidative crosslinking throughout the resin film. Oximes, which act as oxygen scavengers, or suitable phenolic compounds are most often used as anti-skinning agents in industry. However, phenolic anti-skinning agents result in a significant delay in surface drying such that alone they are only suitable for certain coating compositions. Oximes such as e.g. methyl ethyl ketoxime (MEKO) or butyraldoxime, on the other hand, display only slight delays in surface drying due to their volatility. The high volatility of oximes results in rapid loss of this anti-skin agent from the alkyd in a storage can or applied film and thus does not adequately control skinning. The most significant disadvantage of the oximes, which are widely used today, lies in their toxicity. As a consequence of this, users have to observe elaborate personal protection precautions when working with paints containing oximes as anti-skinning agents.

Oxygen scavenges alone, such as DEHA, are sufficient to inhibit or slow the propensity for skinning at the air-alkyd interface. However, DEHAs relativity low volatility causes delayed dry-through performance. For example, the addition of 500 ppm DEHA to an alkyd is sufficient to slow skinning but it may take hours to days for the alkyd layer to completely dry.

It was discovered that the use of the combination of an organic or inorganic oxygen scavenger and a nitrogen-containing aromatic compound in an air dry coating containing a metal dryer provides for inhibition of skinning with minimal impact on drying properties. In particular, the above-mentioned disadvantages of the specified hydroxylamines as anti-skinning agents could also be avoided by combining one or more organic or inorganic oxygen scavengers with a nitrogen-containing aromatic compound, and hence products that better satisfy requirements as anti-skinning agents are obtained.

Incorporating a combination of one or more organic or inorganic oxygen scavengers with a nitrogen-containing aromatic compound in an air dry coating containing a metal dryer according to the present invention into an air-drying coating such as an alkyd resin coating provides an alkyd resin system which is resistant to undesirable skinning and exhibits improved drying of the resin films after application.

### DETAILED DESCRIPTION OF THE INVENTION

The present invention relates to the combination of an organic or inorganic anti-skinning agent with a nitrogen-containing aromatic compound. The oxygen scavenges can be, independently, organic or inorganic. It was found that such a combination provides effective anti-skinning control while providing acceptable dry through. This combination allows for effective control of both the skinning and dry through processes. The control of skinning, that is the drying at the air-resin interface and the control of dry through or the drying of the entire resin coating are both of concern in resin coating formulation. It was discovered that proper selection of one or more oxygen scavengers with a nitrogen-containing aromatic compound in an air dry coating containing a metal dryer can provide for control of both properties while limiting the materials added to the resin base.

An organic or inorganic oxygen scavenger is a material which exhibits the ability to complex with free oxygen and slow its oxidative reactions. Representative examples of organic oxygen scavengers include but are not limited to: hydroquinones, substituted hydroquinones, semi-hydroquinones, catechol, substituted catechols, erythorbic acid, ascorbic acid, hydroxylamine compounds, carbohydrazides and methyl ethyl ketoxime. Representative examples of inorganic oxygen scavengers include but are not limited to hydrazine and sulfites. The present invention contemplates combinations of one or more organic or inorganic oxygen scavengers selected such that skinning is controlled along with a nitrogen-containing aromatic compound.

Representative nitrogen-containing aromatic compounds include but are not limited to: 1,10-phenanthroline, substituted 1,10-phenanthroline derivatives including but not limited to 4-methyl-1,10phenanthroline, 5-methyl-1,10-phenanthroline, 4,7dimethyl-1,10-phenanthroline, 5,6-dimethyl-1,10phenanthroline, 3,4,7,8-tetramethyl 1,10-phenanthroline, 4,7-diphenyl-1,10-phenanthroline, 2,9-dimethyl-4,7-dimethyl-1,10-phenanthroline; 2-hydroxyquinoline, 8-hydroxyquinoline and their substituted derivatives including but not limited to 8-hydroxyquinaldine, 2-hydroxy-4-methylquinaldine, 5-chloro-8-hydroxyquinoline, 5,7-dichloro-8-hydroxyquinoline, 2,4-quinolinediol; 2-quinolinethiol, 8-quinolinethiol and their derivatives; 8-aminoquinoline and its derivatives; 2,2′-bipyridine and substituted 2,2′-bipyridine including but not limited to 4,4′-dimethyl-2,2′-dipyridyl, 2,2′:6′,2″-terpyridine, 4,4′-diphenyl-2,2′dipyridyl, 2,2′-dipyridine-3,3′-diol; 2,2′-biquinoline; 2-quinoxalinol; 3-methyl-2-quinoxalinol; 2,3-dihydroxyquinoxaline; and mixtures thereof.

Hydroxylamine oxygen scavengers in accordance with the present invention are of the general formula: 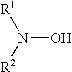
where R¹ and R² mutually independently hydrogen, a linear or branched, saturated or unsaturated C₁-C₂₀ aliphatic molecule or radical, which can optionally be mono- or polysubstituted, or a C₆-C₁₂ aryl molecule or radical, a C₇-C₁₄ araliphatic molecule or radical or a C₅-C₇ cycloaliphatic.

Representative hydroxylamine compounds include but are not limited to: hydroxylamine, methylhydroxylamine, dimethylhydroxylamine, methylethylhydroxylamine, ethylhydroxylamine, diethylhydroxylamine, dibutylhydroxylamine, dibenzylhydroxylamine, mono-isopropylhydroxylamine and mixtures thereof. A preferred hydroxylamine is diethylhydroxylamine (DEHA).

Hydroquinone oxygen scavengers in accordance with the present invention may be unsubstituted or substituted. The substituted hydroquinone oxygen scavengers can be substituted in the ortho or meta positions or both with moieties including but not limited to C-1 to C-6 alkyl or aryl moieties. Representative examples of substituted hydroquinones include but are not limited to methyl hydroquinone.

The nitrogen-containing aromatic compound of the present invention acts as a drier promoter in with the metal drier in the air drying coating. The nitrogen-containing aromatic compound is capable of interacting or complexing with the transition metal drier and will typically have at least one and possibly more than one nitrogen atoms per aromatic ring. The aromatic ring may further be substituted with atoms other than hydrogen such as oxygen, halogens or sulfur.

The invention also relates to compositions of matter such as coating materials, paints or finishes containing such a combination of anti-skinning agents.

For the purposes of the invention, the combination of one or more organic or inorganic oxygen scavengers with the nitrogen-containing aromatic compound is used alone or as solutions, dispersions or emulsions in water and/or organic solvents. Suitable organic solvents include all conventional solvents, such as aromatics, white spirits, ketones, alcohols, ethers and fatty acid esters. The present invention provides for a novel means of balancing the need for a rapid dry through of a resin coating, such as an alkyl resin coating, while maintaining an acceptable oxidative control at the air-resin interface to control skinning.

For use according to the present invention the combination of one or more organic or inorganic oxygen scavengers with a nitrogen-containing aromatic compound can be used in a broad range of mixtures with one another. They are preferably used in the ratio of the oxygen scavenger (A) to nitrogen-containing aromatic compound (B) of (A):(B) from 0.01:75 to 75:0.01, preferably from 0.05:30 to 30:0.05 and most preferably from 0.1:10 to 10:0.1 parts. They can be used in pure form or in aqueous solution or aqueous dispersion or emulsion or in the form of solutions in organic solvents. Aqueous in this context is intended to mean that water is either the sole solvent or is added in a quantity of over 50 wt. % relative to the solvent blend together with conventional organic solvents (e.g. alcohols).

The amount of anti-skinning agent/nitrogen-containing aromatic compound combination used in a coating system primarily depends on the content of binder and drier used in the particular coating composition. As a general rule between about 0.001 and 2.0 wt. % of mixtures of oxygen scavenger to the nitrogen-containing aromatic compound combination according to the present invention should be added. Preferred amounts to be used are about 0.01 to 0.5 wt. %, relative in each case to the overall composition of the coating composition. The amounts can also depend on the type of binder and the pigments used in the coating composition. Thus, in special systems the relative amount of additive to be used can also be greater than about 2.0 wt. % (relative to the overall composition).

It is an advantage of the anti-skinning agent combination of the present invention that it reliably prevents skinning in a wide range of binders and when used with various driers but that it does not unfavorably influence other drying properties of the resin such as dry through.

The invention is further illustrated by, but is not intended to be limited by, the following examples in which all parts and percentages are by weight unless otherwise specified.

### EXAMPLES

### Example 1

This example shows the performance of a combination of a nitrogen-containing aromatic transition metal co-promoters with oxygen scavengers to aid in minimizing skinning. A common short oil resin, Beckosol 12054 (available from Reichhold Chemicals, Inc.), containing 50% solids was used to compare nitrogen-containing aromatic co-promoters alone to combinations of the nitrogen-containing aromatic co-promoters with oxygen scavengers such as DEHA and methyl ethyl ketoxime. Cobalt octoate, a metal dryer, was added to the resin so the final cobalt ion concentration was 0.2%. To the resin-cobalt mixture was added 0.05% by weight 1,10 phenathroline and either DEHA or MEKO (available as a 25% active solution). Ten-gram samples were placed in bottles and a small hole was drilled into the cap so air could enter into the bottles. Air was swept over the top of the bottles using a flow rate of about 100 feet per minute. The onset of skinning was monitored daily with the following results:

| | | | | Resin + Co⁺⁺ + | Resin + Co⁺⁺ + |
|---|---|---|---|---|---|
| | | | | 0.05% 1,10- | 0.05% 1,10- |
| | Resin + Co⁺⁺ + | Resin + | Resin + | Phenanothroline + | Phenanothroline + |
| Resin + | 0.05% 1,10- | Co⁺⁺ + MEKO | Co⁺⁺ + DEHA | 350 ppm | 350 ppm |
| Co⁺⁺ | Phenanothroline | (350 ppm) | (350 ppm) | DEHA | MEKO |
| 5 Days | 2 Days | 10 Days | 21 Days | 19 Days | 9 Days |

The resin catalyzed with cobalt alone showed poor resistance to skinning. The sample containing 1,10 phenathroline with cobalt skinned even faster than that without 1,10 phenathroline showing the catalytic activity of this additive. The sample containing DEHA skinned very slowly whereas those containing an oxygen scavenger with 1,10 phenathroline skinned in from 12-19 days.

### Example 2

This example shows the dry-through performance of the short-oil resin used in Example 1. The cobalt concentration for this dry-through performance study was decreased to 0.1%. The resin with the cobalt drier, the transition metal co-promoter and the antiskinning agents were placed onto substrate and a drawdown bar was used to apply a three mil thick coating. The samples were placed in an exhaust hood with air flowing over the samples at about 100 feet per minute. The tack-free time was determined by the absence of a fingerprint on the resin.

The dry-through performance was monitored using a methyl ethyl ketone (MEK) double-rub (DR). Cheesecloth was soaked in MEK for about ten seconds then applied to the resin using a downward force of one pound per square in (1 psi). One complete rub was counted as a forward and backward stroke. The number of double-rubs necessary to remove the resin is an indication of the dry-through: the higher the number of MEK double rubs (DRs), the faster the dry-through.

| | | | | Blank + | Blank + Co⁺⁺ + | |
|---|---|---|---|---|---|---|
| | | | Blank + Co⁺⁺ + | Co⁺⁺ + | 0.05% 1,10- | Blank + Co⁺⁺ + |
| | | Blank + Co⁺⁺ + | MEKO | DEHA (350 | Phenanothroline + | 0.05% 1,10- |
| | | 0.05% 1,10- | (350 ppm) | ppm) | 350 ppm | Phenanothroline + |
| | Blank + Co⁺⁺ | Phenanothroline | Tack Free | Tack Free | DEHA | 350 ppm MEKO |
| | Tack Free Time < | Tack Free Time < | Time < | Time < | Tack Free Time < | Tack Free Time < |
| Drying Time | 10 mins | 10 mins | 10 mins | 10 mins | 10 mins | 10 mins |
| 5 Hours | MEK DRs | MEK DRs | MEK DRs | MEK DRs | MEK DRs | MEK DRs |
| | <3 | <3 | <3 | <3 | <3 | <3 |
| 25 Hours | MEK DRs | MEK DRs | MEK DRs | MEK DRs | MEK DRs | MEK DRs |
| | 5 | 6 | 6 | 2 | 5 | 6 |
| 125 Hours | MEK DRs | MEK DRs | MEK DRs | MEK DRs | MEK DRs | MEK DRs |
| | 6 | 9 | 8 | 6 | 7 | 8 |
| 250 Hours | MEK DRs | MEK DRs | MEK DRs | MEK DRs | MEK DRs | MEK DRs |
| | 20 | 30 | 22 | 23 | 25 | 30 |
| 450 Hours | MEK DRs | MEK DRs | MEK DRs | MEK DRs | MEK DRs | MEK DRs |
| | 25 | 30 | 25 | 25 | 30 | 30 |

The resin containing the metallic drier co-promoter showed slightly faster dry-through rate due to its catalytic activity but yielded the poorest anti-skinning performance as seen in Example 1. The samples containing 1,10 phenathroline along with an oxygen scavenger such as DEHA or MEKO showed similar dry-through properties to the sample containing only 1,10 phenathroline but much better antiskin properties as seen in Example 1.

### Example 3

This example shows the performance of another nitrogen-containing aromatic transition metal co-promoter, 8-hydroxyquinoline with oxygen scavengers to aid in minimizing skinning. The same short oil resin used in Example 1, Beckosol 12054 (available from Reichhold Chemicals, Inc.), containing 50% solids was used to compare nitrogen-containing aromatic co-promoters alone to combinations of the nitrogen-containing aromatic co-promoters with oxygen scavengers such as DEHA or methyl ethyl ketoxime. Cobalt octoate, a metal dryer, was added to the resin so the final cobalt ion concentration was 0.2%. To the resin-cobalt mixture was added 0.05% by weight 8-hydroxyquinoline and either DEHA or MEKO (available as a 25% active solution). Ten-gram samples were placed in bottles and a small hole was drilled into the cap so air could enter into the bottles. Air was swept over the top of the bottles using a flow rate of about 100 feet per minute. The onset of skinning was monitored daily with the following results:

| | | | | | Resin + Co⁺⁺ + |
|---|---|---|---|---|---|
| | | | | Resin + Co⁺⁺ + | 0.05% 8- |
| | Resin + Co⁺⁺ + | Resin + Co⁺⁺ + | Resin + Co⁺⁺ + | 0.05% 8- | Hydroxyquilonine + |
| Resin + | 0.05% 8- | MEKO (350 | DEHA (350 | Hydroxyquinoline + | 350 ppm |
| Co⁺⁺ | Hydroxyquinoline | ppm) | ppm) | 350 ppm DEHA | MEKO |
| 5 Days | 3 Days | 10 Days | 21 Days | 19 Days | 7 Days |

The resin catalyzed with cobalt alone showed poor resistance to skinning. The sample containing 8-hydroxyquinoline with cobalt skinned even faster than that without 8-hydroxyquinoline showing the catalytic activity of this additive. The sample containing DEHA skinned the slowest whereas those containing an oxygen scavenger with 8-hydroxyquinoline skinned from 17-19 days.

### Example 4

This example shows the dry-through performance of the short-oil resin used in Example 1. However, the cobalt concentration for this dry-through performance study was decreased to 0.1%. The resin with the cobalt drier, the transition metal co-promoter and the antiskinning agents were placed onto substrate and a drawdown bar was used to apply a three mil thick coating. The samples were placed in an exhaust hood with air flowing over the samples at about 100 feet per minute. The tack-free time was determined by the absence of a fingerprint on the resin.

The dry-through performance was monitored using a methyl ethyl ketone (MEK) double-rub. Cheesecloth was soaked in MEK for about ten seconds then applied to the resin using a downward force of one pound per square in (1 psi). One complete rub was counted as a forward and backward stroke. The number of double-rubs necessary to remove the resin is an indication of the dry-through: the higher the number of MEK double rubs (DR), the faster the dry-through.

| | | | Blank + | Blank + | Blank + Co⁺⁺ + | Blank + Co⁺⁺ + |
|---|---|---|---|---|---|---|
| | | | Co⁺⁺ + | Co⁺⁺ + | 0.05% 8- | 0.05% 8- |
| | | Blank + Co⁺⁺ + | MEKO | DEHA | Hydroxyquinoline + | Hydroxyquinoline + |
| | Blank + Co⁺⁺ | 0.05% 8- | (350 ppm) | (350 ppm) | 350 ppm | 350 ppm |
| | Tack Free | Hydroxyquinoline | Tack Free | Tack Free | DEHA | MEKO |
| | Time < | Tack Free | Time < | Time < | Tack Free | Tack Free Time < |
| Drying Time | 10 mins | Time < 10 mins | 10 mins | 10 mins | Time < 10 mins | 10 mins |
| 5 Hours | MEK DRs | MEK DRs | MEK DRs | MEK DRs | MEK DRs | MEK DRs |
| | <3 | <3 | <3 | <3 | <3 | <3 |
| 25 Hours | MEK DRs | MEK DRs | MEK DRs | MEK DRs | MEK DRs | MEK DRs |
| | 2 | 5 | 6 | 2 | 5 | 6 |
| 125 Hours | MEK DRs | MEK DRs | MEK DRs | MEK DRs | MEK DRs | MEK DRs |
| | 6 | 10 | 8 | 6 | 9 | 9 |
| 250 Hours | MEK DRs | MEK DRs | MEK DRs | MEK DRs | MEK DRs | MEK DRs |
| | 20 | 30 | 22 | 23 | 25 | 30 |
| 450 Hours | MEK DRs | MEK DRs | MEK DRs | MEK DRs | MEK DRs | MEK DRs |
| | 25 | 33 | 25 | 25 | 30 | 30 |

The resin containing the metallic drier co-promoter showed slightly faster dry-through rate due to its catalytic activity but yielded the poorest anti-skinning performance as seen in Example 3. The samples containing 8-hydroxyquinoline along with an oxygen scavenger such as DEHA or MEKO showed similar dry-through properties to the sample containing only 8-hydroxyquinoline but much better antiskin properties as seen in Example 3.

### Example 5

This example shows the skinning of soybean oil, an oil used in many alkyd formulations to assist in curing of the resin. To a sample of soybean oil was added 0.1% cobalt (II), added as cobalt octoate. Samples also contained 8-hydroxyquinoline, MEKO or DEHA alone or 8-hydroxyquinoline with conventional antiskin agents. The onset of skinning is shown below:

| | | | | Blank + | Blank + | | |
|---|---|---|---|---|---|---|---|
| | | | | Co⁺⁺+ | Co⁺⁺ + | Blank + Co⁺⁺ + | Blank + Co⁺⁺ + |
| | | | | MEKO | DEHA | 0.05% 8- | 0.05% 8- |
| | | | Blank + Co⁺⁺ + 8- | (350 | (350 | Hydroxyquinoline + | Hydroxyquinoline + |
| Days | Blank | Blank + Co⁺⁺ | Hydroxyquinoline | ppm) | ppm) | 350 ppm DEHA | 350 ppm MEKO |
| 0 | 0 | 0 | 0 | 0 | 0 | 0 | 0 |
| 1 | 0 | 0 | 0 | 0 | 0 | 0 | 0 |
| 2 | 0 | 0 | 1 | 0 | 0 | 0 | 1 |
| 3 | 0 | 0 | 2 | 0 | 0 | 1 | 1 |
| 4 | 0 | 0 | 3 | 0 | 0 | 1 | 1 |
| 5 | 0 | 1 | 3 | 0 | 0 | 2 | 2 |
| 6 | 0 | 1 | 4 | 1 | 0 | 3 | 2 |
| 7 | 0 | 2 | 5 | 1 | 1 | 3 | 2 |
| 8 | 0 | 2 | 6 | 1 | 1 | 3 | 3 |
| 9 | 0 | 3 | 6 | 2 | 2 | 3 | 3 |
| 10 | 0 | 3 | 7 | 2 | 2 | 4 | 4 |
| 11 | 0 | 3 | 8 | 2 | 2 | 4 | 4 |
| 12 | 0 | 4 | 8 | 3 | 2 | 4 | 5 |
| 13 | 0 | 4 | 9 | 3 | 3 | 5 | 5 |
| 14 | 0 | 4 | 9 | 3 | 3 | 5 | 6 |
| 15 | 0 | 5 | 10 | 4 | 3 | 6 | 6 |
| 16 | 0 | 5 | 10 | 4 | 4 | 6 | 6 |
| 17 | 0 | 5 | 10 | 5 | 4 | 6 | 7 |
| 18 | 0 | 6 | 10 | 5 | 5 | 7 | 7 |
| 19 | 0 | 6 | 10 | 6 | 5 | 7 | 7 |
| 20 | 0 | 7 | 10 | 6 | 6 | 8 | 8 |
| 21 | 0 | 7 | 10 | 7 | 6 | 8 | 8 |

Note:
All samples contained 0.1% Cobalt
Rankings:
0 - No Skin
2 - Light Sheen
4 - Starting to Skin
6 - Incomplete Skin
8 - Complete Soft Skin
10 - Coherent Hard Skin

The sample containing the nitrogen-aromatic accelerator skinned the fastest, as expected, whereas those containing only the conventional anti-skin additives (MEKO or DEHA) skinned the slowest. Those soybean oil samples containing the anti-skin additives and the nitrogen-containing aromatic accelerator skinned between the sample containing only 8-hydroxyquinoline and the anti-skin additives alone thus demonstrating the ability to control the onset of skinning by adjusting the anti-skin additive formation—using the two component additive system.

### Example 6

This example shows the skinning of soybean oil, an oil used in many alkyd formulations to assist in curing of the resin. To a sample of soybean oil was added 0.1% cobalt (II), added as cobalt octoate. Samples also contained 1,10 phenathroline, MEKO or DEHA alone or 1,10 phenathroline with conventional antiskin agents. The onset of skinning is shown below:

| | | | | | Blank + | Blank + Co⁺⁺ + | Blank + Co⁺⁺ + |
|---|---|---|---|---|---|---|---|
| | | | Blank + Co⁺⁺ + | Blank + Co⁺⁺ + | Co⁺⁺ + | 0.05% 1,10- | 0.05% 1,10- |
| | | | 0.05% 1,10- | MEKO | DEHA | Phenanothroline + | Phenanothroline + |
| Days | Blank | Blank + Co⁺⁺ | Phenanothroline | (350 ppm) | (350 ppm) | 350 ppm DEHA | 350 ppm MEKO |
| 0 | 0 | 0 | 0 | 0 | 0 | 0 | 0 |
| 1 | 0 | 0 | 0 | 0 | 0 | 0 | 1 |
| 2 | 0 | 0 | 1 | 0 | 0 | 1 | 1 |
| 3 | 0 | 0 | 1 | 0 | 0 | 1 | 1 |
| 4 | 0 | 0 | 2 | 0 | 0 | 2 | 2 |
| 5 | 0 | 1 | 3 | 0 | 0 | 2 | 2 |
| 6 | 0 | 1 | 4 | 1 | 0 | 2 | 3 |
| 7 | 0 | 2 | 4 | 1 | 1 | 3 | 3 |
| 8 | 0 | 2 | 5 | 1 | 1 | 3 | 3 |
| 9 | 0 | 3 | 6 | 2 | 2 | 3 | 4 |
| 10 | 0 | 3 | 7 | 2 | 2 | 4 | 4 |
| 11 | 0 | 3 | 7 | 2 | 2 | 4 | 5 |
| 12 | 0 | 4 | 8 | 3 | 2 | 5 | 5 |
| 13 | 0 | 4 | 8 | 3 | 3 | 5 | 5 |
| 14 | 0 | 4 | 9 | 3 | 3 | 5 | 6 |
| 15 | 0 | 5 | 9 | 4 | 3 | 6 | 6 |
| 16 | 0 | 5 | 9 | 4 | 4 | 6 | 7 |
| 17 | 0 | 5 | 10 | 5 | 4 | 6 | 7 |
| 18 | 0 | 6 | 10 | 5 | 5 | 7 | 7 |
| 19 | 0 | 6 | 10 | 6 | 5 | 7 | 8 |
| 20 | 0 | 7 | 10 | 6 | 6 | 7 | 8 |
| 21 | 0 | 7 | 10 | 7 | 6 | 8 | 9 |

Note:
All samples contained 0.1% Cobalt
Rankings:
0 - No Skin
2 - Light Sheen
4 - Starting to Skin
6 - Incomplete Skin
8 - Complete Soft Skin
10 - Coherent Hard Skin

The sample containing the nitrogen-aromatic accelerator skinned the fastest, as expected, whereas those containing only the conventional anti-skin additives (MEKO or DEHA) skinned the slowest. Those soybean oil samples containing the anti-skin additives and the nitrogen-containing aromatic accelerator skinned between the sample containing only 1,10 phenathroline and the anti-skin additives alone thus demonstrating the ability to control the onset of skinning by adjusting the anti-skin additive formation—using the two component additive system.

While the present invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

What is claimed is:

1. A coating material, paint or finish which contains an oxidatively drying film former and, as an antiskinning agent, a combination comprising at least one oxygen scavengers selected from organic oxygen scavengers, inorganic oxygen scavengers and mixtures thereof and a nitrogen-containing aromatic compound.

2. The coating material, paint or finish of claim 1 wherein said at least one oxygen scavenger is independently selected from hydroquinone, hydrazine, substituted hydroquinones, semi-hydroquinone, catechol, substituted catechols, erythorbic acid, ascorbic acid, hydroxylamine compounds, carbohydrazides, methyl ethyl ketoxime and sulfites.

3. The coating material, paint or finish of claim 1, wherein said hydroxylamine is of the formula 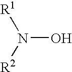
where R¹ and R² mutually independently hydrogen, a linear or branched, saturated or unsaturated C₁-C₂₀ aliphatic molecule or radical, which can optionally be mono- or polysubstituted, or a C₈-C₁₂ aryl molecule or radical, a C₇-C₁₄ araliphatic molecule or radical or a C₅-C₇ cycloaliphatic.

4. The coating material, paint or finish of claim 2, wherein said hydroquinone is substituted in the ortho and/or meta positions with C-1 to C-6 alkyl or aryl moieties.

5. The coating material of claim 1 wherein said nitrogen-containing aromatic compound is selected from: 1,10-phenanthroline, substituted 1,10-phenanthroline derivatives; 2-hydroxyquinoline and 8-hydroxyquinoline and their substituted derivatives; 2-quinolinethiol, 8-quinolinethiol and their derivatives; 8-aminoquinoline and its derivatives; 2,2′-bipyridine and substituted 2,2′-bipyridine; 2,2′-biquinoline; 2-quinoxalinol; 3-methyl-2-quinoxalinol; 2,3dihydroxyquinoxaline; and mixtures thereof.

6. The coating material of claim 5 wherein said 1,10-phenanthroline derivatives are selected from the group consisting of 4-methyl-1,10phenanthroline, 5-methyl-1,10-phenanthroline, 4,7dimethyl-1,10-phenanthroline, 5,6-dimethyl-1,10-phenanthroline, 3,4,7,8-tetramethyl 1,10-phenanthroline, 4,7-diphenyl-1,10-phenanthroline, 2,9-dimethyl-4,7-dimethyl-1,10-phenanthroline.

7. The coating material of claim 5 wherein said substituted derivatives of 2-hydroxyquinoline and 8-hydroxyquinoline are selected from the group consisting of 8-hydroxyquinaldine, 2-hydroxy-4methylquinaldine, 5-chloro-8-hydroxyquinoline, 5,7-dichloro-8-hydroxyquinoline, 2,4-quinolinediol.

8. The coating material of claim 5 wherein said substituted 2,2′-bipyridine is selected from the group consisting of 4,4′-dimethyl-2,2′-dipyridyl, 2,2′:6′,2″-terpyridine, 4,4′-diphenyl-2,2′dipyridyl, 2,2′-dipyridine-3,3′-diol.

9. The coating material, paint or finish of claim 1, which contains said combination in an amount of from 0.001 to 2% by weight, based on the total weight of the coating material, paint or finish.

10. The coating material, paint or finish of claim 1, which contains said combination in an amount of from 0.01 to 0.5% by weight, based on the total weight of the coating material, paint or finish.

11. The coating material, paint or finish of claim 1, wherein said combination comprises a first oxygen scavenger and a second oxygen scavenger, each independently organic or inorganic.

12. The coating material, paint or finish of claim 11, wherein the ratio of said first oxygen scavenger to said second oxygen scavenger ranges from about 0.01 to 75 to about 75 to 0.01.

13. The coating material, paint or finish of claim 1, wherein said oxidatively drying film former is an alkyd resin.

14. The coating material, paint or finish of claim 1, further comprising a metal selected from groups 1A, 2A, 3A, 4A, 5A, 1B, 2B, 3B, 4B, 5B, 6B, 7B and 8B of the periodic tale or combinations thereof.

15. The coating material, paint or finish of claim 14, wherein said metal is cobalt.

16. A process for the production of a coating material, paint or finish containing an oxidatively drying film former comprising incorporating into the coating material, paint or finish, an antiskinning combination comprising at least one oxygen scavenger selected from organic oxygen scavengers, inorganic oxygen scavengers and mixtures thereof and a nitrogen-containing aromatic compound.

17. The process of claim 16, wherein each of said at least one oxygen scavenger is selected from hydroquinone, hydrazine, substituted hydroquinones, semi-hydroquinones, catechol, substituted catechols, erythorbic acid, ascorbic acid, hydroxylamine compounds, carbohydrazides, methyl ethyl ketoxime and sulfites.

18. The process of claim 17, wherein said hydroxylamine is of the formula 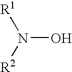
where R¹ and R² mutually independently hydrogen, a linear or branched, saturated or unsaturated C₁-C₂₀ aliphatic molecule or radical, which can optionally be mono- or polysubstituted, or a C₆-C₁₂ aryl molecule or radical, a C₇-C₁₄ araliphatic molecule or radical or a C₅-C₇ cycloaliphatic.

19. The process of claim 17, wherein said substituted hydroquinone is substituted in the ortho and/or meta positions with C-1 to C-6 alkyl or aryl moieties.

20. The process of claim 16 wherein said nitrogen-containing aromatic compound is selected from: 1,10-phenanthroline, substituted 1,10-phenanthroline derivatives; 2-hydroxyquinoline and 8-hydroxyquinoline and their substituted derivatives; 2-quinolinethiol, 8-quinolinethiol and their derivatives; 8-aminoquinoline and its derivatives; 2,2′-bipyridine and substituted 2,2′-bipyridine; 2,2′-biquinoline; 2-quinoxalinol; 3-methyl-2-quinoxalinol; 2,3dihydroxyquinoxaline; and mixtures thereof.

21. The process of claim 20 wherein said 1,10-phenanthroline derivatives are selected from the group consisting of 4-methyl-1,10phenanthroline, 5-methyl-1,10-phenanthroline, 4,7dimethyl-1,10-phenanthroline, 5,6-dimethyl-1,10-phenanthroline, 3,4,7,8-tetramethyl 1,10-phenanthroline, 4,7-diphenyl-1,10-phenanthroline, 2,9-dimethyl-4,7-dimethyl-1,10-phenanthroline.

22. The process of claim 20 wherein said substituted derivatives of 2-hydroxyquinoline and 8-hydroxyquinoline are selected from the group consisting of 8-hydroxyquinaldine, 2-hydroxy-4methylquinaldine, 5-chloro-8-hydroxyquinoline, 5,7-dichloro-8-hydroxyquinoline, 2,4-quinolinediol.

23. The process of claim 20 wherein said substituted 2,2′-bipyridine is selected from the group consisting of 4,4′-dimethyl-2,2′-dipyridyl, 2,2′:6′,2″-terpyridine, 4,4′-diphenyl-2,2′dipyridyl, 2,2′-dipyridine-3,3′-diol.

24. The process of claim 16, wherein said coating, paint or finish contains said antiskinning combination in an amount of from 0.001 to 2% by weight, based on the total weight of the coating, paint or finish.

25. The process of claim 16, wherein said oxidatively drying film former is an alkyd resin.

26. The process of claim 16, wherein said coating material, paint or finish further comprising a metal selected from groups 1A, 2A, 3A, 4A, 5A, 1B, 2B, 3B, 4B, 5B, 6B, 7B and 8B of the periodic table or combinations thereof.

27. The process of claim 26, wherein said metal is cobalt.
